(19) United States
(12) Patent Application Publication
(10) Pub. No.: US 2005/0207548 A1
(43) Pub. Date: Sep. 22, 2005

(54) Method and apparatus for complying with predictive dialer requirements

(76) Inventors: Mark Moore, Fountain Hills, AZ (US); Kathleen Kelly, Scottsdale, AZ (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/014,216

(22) Filed: Dec. 17, 2004

Related U.S. Application Data
(60) Provisional application No. 60/530,666, filed on Dec. 19, 2003.

(51) Int. Cl. H04M 1/24; H04M 3/22

(52) U.S. Cl. 379/112.1; 379/126; 379/32.01

(57) ABSTRACT

Apparatus for assessing compliance with FTC/FCC predictive dialer requirements includes a predictive dialer for dialing selected calls, a call-log data record for recording data necessary to determine for a selected call by said predictive dialer whether said call meets FTC/FCC requirements for calls from a consumer telemarketer, a compliance analyzer, a data transfer agent for transferring data from the call-log data record to said compliance analyzer which is operative to analyze the transferred data to determine whether it is in compliance with said FTC/FCC requirements, and a result presentation system for generating a report to demonstrate compliance with the FTC/FCC requirements.

### BACKGROUND

Field of the Invention

The present invention relates to a method and apparatus for permitting telemarketers to comply with rules and regulations of the Federal Trade Commission and Federal Communications Commission (FTC/FCC) relating to consumer telemarketing.

Predictive dialers dial phone numbers and screen out non-productive calls such as “no answers”, “busy signals”, “disconnected numbers”, “answering machines”, etc. They send “live contacts” (customers) to agents who then talk to the prospective customer. Because of the high percentage of non-productive calls, predictive dialers dial phone numbers before an agent is available to take the call. Predictive dialers use sophisticated pacing algorithms which measure calling activity to predict when an agent is going to be available to take the next call. A dialer can be set to dial very conservatively to make sure that an agent is available before dialing a number; or, it can be set to dial ahead in anticipation of when an agent may be able to take a call if it turns out to be a live contact.

The predictions, however, are not always exactly in keeping with reality. Hence, when dialing ahead, there are usually a number of live contacts which answer when no agent is available to take the call. When this happens, the dialer will either place the live contact on hold while waiting for an agent, or hang up. A hang up is an “abandoned call”.

FTC/FCC regulations now require telemarketers to connect a call with an agent within two seconds of the consumer's completed greeting; and, moreover, telemarketers are not permitted to abandon more than 3 percent of live contacts wherein a call is considered abandoned if there is no agent available to take a call within two seconds of the time a consumer completes his or her greeting. The FTC/FCC requirements therefore are more stringent than the past practices of telemarketers.

In the event a call cannot be connected to an agent within two seconds, the FTC/FCC regulations further require the telemarketer to play a pre-disconnect announcement to the consumer including information such as the company name and it's phone number and a statement that the call was for telemarketing purposes.

Prior to the initiation of the National Do Not Call Registry, telemarketers would customarily let a phone ring only three times to avoid paying toll charges for calls that were answered by answering machines. The FTC/FCC regulations require, however, that telemarketers permit a call to ring for at least 15 seconds (approximately four rings) before determining that a given call is a “no answer”.

The FTC/FCC regulations also require telemarketers to maintain records showing compliance with the above-discussed requirements. Indeed, each violation of the FTC/FCC requirements can result in a fine of as much as $11,000.00.

Hence, telemarketer which are responsible for many billions of dollars in commerce each month, must not only adhere to the FTC/FCC regulations but be able to prove they have done so. Similarly, the FTC/FCC must be able to monitor the activities of telemarketers to determine whether telemarketers are meeting the FTC/FCC requirements. Various aspects of the instant invention therefore, are intended to make a determination of whether a given telemarketer is meeting one or more or all of the above-discussed requirements.

### SUMMARY

Apparatus for assessing compliance with predictive dialer requirements includes, a call-log database and, if desired, an audio recorder for recording data necessary to determine for a selected call one or more of the following:

whether it was a live contact and, if so, whether it was abandoned; the length of time between a completed greeting of an answering party and the connection of the call to an agent; if a pre-recorded message was played for abandoned calls and, the length of time a party's phone rang, before a determination was made that there was “no answer”. A compliance analyzer is used to determine:

whether the number of abandoned calls exceeds a predetermined number of live contacts; whether a given live contact was connected to an agent within a predetermined time period; whether a given phone was permitted to ring for a given period of time before the call was determined to be a “no answer”; and, whether a pre-disconnect announcement was played when a given call could not be connected to an agent within a predetermined time period.

### BRIEF DESCRIPTION OF THE DRAWINGS

FIG. 1 is a block diagram showing an overall relationship between a predictive dialer, a compliance monitor system and a compliance analyzer system.

FIG. 2 is a block diagram showing details of the compliance analyzer.

### DETAILED DESCRIPTION

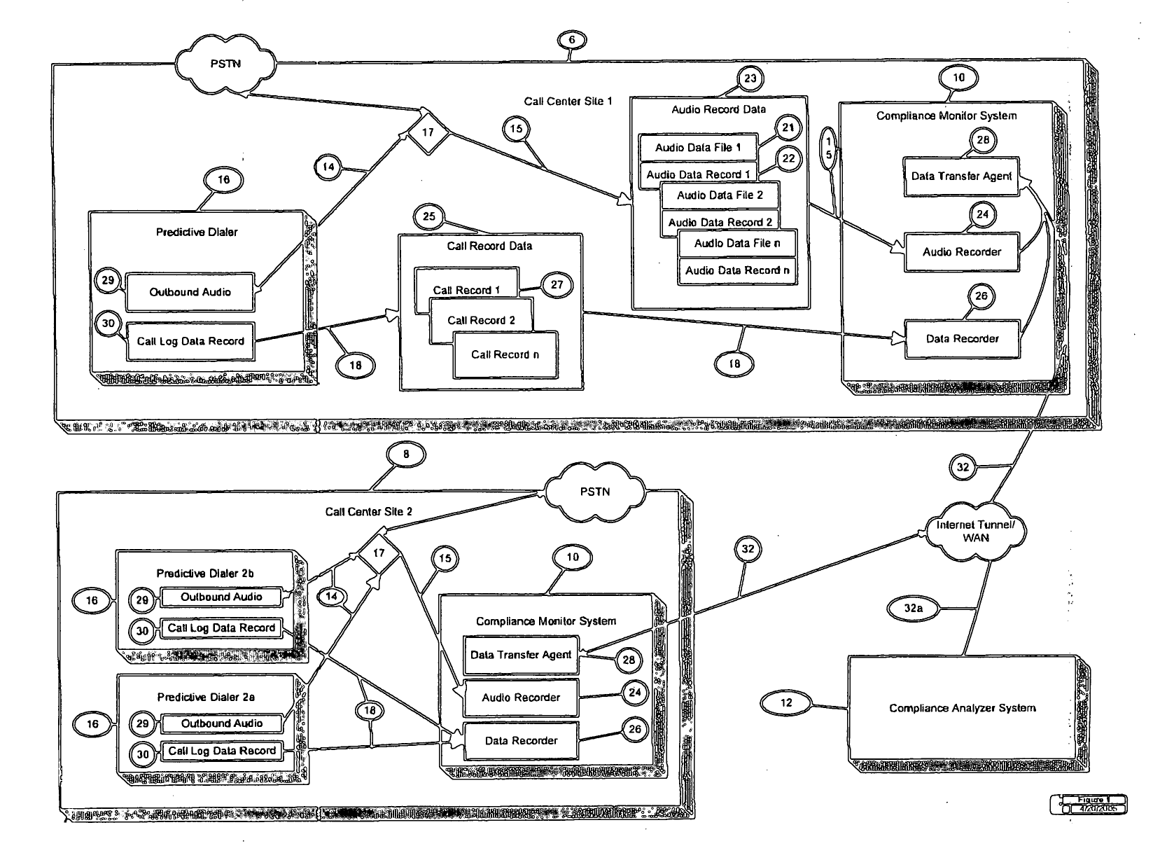

With reference to FIG. 1, a preferred embodiment of the invention includes one or more compliance monitors 10 and a compliance analyzer 12. The compliance monitors are located at each of a plurality of call-center sites. One or more predictive dialers 16 at each call-center site are connected to a public switch telephone network (PSTN) which receives each outgoing call from each predictive dialer. The compliance monitor 10 gathers call log data records in a Data Recorder 26 on all calls placed by the predictive dialers. If desired, each compliance monitor 10 can be adapted to record some or all of the audio data received on lines 14 and 15, through hub 17, from predictive dialers 16 as a given call progresses from a predictive dialer to the PSTN. In this respect, all audio data can be recorded if required. Even if FTC/FCC should require copies of audio data for proof of compliance purposes, however, it is anticipated that a sampling of only 15-25% or so of outgoing calls should be sufficient. Hence, it is anticipated that it will only be necessary to record a portion of the audio data rather than all. On the other hand, if it is desired to be able to retrieve an audio copy of a given customer's call initiation that data can be recorded.

Each compliance monitor 10 includes a call-data recorder 26 for logging call data; a data transfer component (data transfer agent) 28; and may include an audio-recording component 24 for recording audio data being transmitted to and from the PSTN through hubs 17 on line 15. The compliance monitors can be conveniently installed at call centers and, as the predictive dialers dial calls in connection with given sales campaigns, they are also connected to the compliance monitors by lines 18 for data collection purposes.

The compliance analyzer 12 can be located at the call center site, but more conveniently it is remotely located at a remote compliance-management location which receives similar data from a plurality of call-center sites 1 through n as illustrated in blocks 6 and 8 of FIG. 1 wherein each call center site has one or more predictive dialers and at least one compliance monitor 10.

Each predictive dialer 16 also includes many call-log data records 30; and, the data recorder 26 in the monitor 10 receives all such desired data in the form of a compliance-monitor call record to be detailed shortly. This data in the dialer's calling log data record 30 is recorded for every telephone number that is dialed by the predictive dialer 16. That data located in the calling log data record 30 of the predictive dialer 16, however, is in a pre-record format and is transferred on line 18 to a data recorder section 26 of the compliance monitor 10.

Each record can preferably include all or some such data fields as:

d1. For all outbound dials, the consumer telephone number dialed.

d2. For all outbound dials, the date and time each call was initiated.

d3. For all outbound dials, an identification (description) of the physical outbound-line.

d4. For live contacts only, the date and time of the consumer's completed greeting.

d5. For live contacts only, the date and time the call transfer to the agent was initiated.

d6. For non-answered calls only, the date and time each call was determined a no answer.

d7. For all outbound dials, the call classification [busy, live, answering machine, modem/fax, disconnect tone (SIT), abandoned call, no answer, or some other such designation].

d8. For all outbound dials the Call Classification Method, i.e., whether it was classified by the system as or by an agent.

d9. For all abandoned calls, whether a pre-disconnect message was played (Yes or No).

d10. For all abandoned calls, the date and time the pre-disconnect message playing was initiated.

d11. For all abandoned calls, where available, a description of the message that was played.

d12. For all calls, a Campaign Identifier

d13. For all calls, a Client Identifier

d14. For all calls sent to an agent an Identifier of the agent to whom the call was connected.

d15. For all calls, a final result code of the call. (Sale/No Sale, scheduled-call-back, etc.)

d16. For all calls where a caller identification is modified by the system, the caller value that is sent to the PSTN.

This data gathered in the Data Recorder 26 in the Compliance Monitor 10 is sent to the Data Transfer Agent 28 section of the Compliance Monitor 10.

The call-log data from section 30 of the predictive dialer 16 is conventionally mapped to the call log data source in the data recorder section 26 of the compliance monitor 10. In this respect, the call-log data records items d1-d16 above that are transferred in connection with a first sales-campaign customer's files might be mapped in a different manner than a second such customer's call-log data records, but in each instance, such mapping is done in a conventional manner. Once mapped, little or minimal change is required from one sales-campaign customer to another.

The suitably mapped data files are then transferred from the data transfer agent section 28 of the compliance monitor to the data-collection section 34 of the compliance analyzer as discussed above.

Each audio recorder 24 is selectively connected to all or part of the outbound calls at hubs 17 from each dialer for selectively or continuously recording such calls if desired. Conventional circuitry is employed to start the recording preferably when the outbound line from the call center initiates the call (goes off-hook) and stops recording at a pre-designated time frame, preferably after the receiving location answers the call (usually the conversation need not be recorded); and, each desired block of such data is captured, if desired, by the audio-recorder 24 as an individual audio-data file 21 with an associated audio data record 22. The actual audio recording file, or the audio data file 21, and the audio data record 22 are combined as audio record data 23 and are sent to the Data Transfer Agent 28.

The audio recording 21 will be mapped later by the Compliance Analyzer to a specific Call Record 27 to facilitate associative comparison if so desired or required. The audio record data 22 are created in a per-record format, and are stored within the compliance monitor system 10 and sent to the Data Transfer Agent 28.

Each audio data record 22 can preferably include all or some such data fields as:

a1. The consumer telephone number dialed.

a2. The date and time each call was initiated.

a3. An identification (description) of the physical outbound-line.

a4. The unique file name of the recording (Audio Data File 21).

Two fields are added in the call record data 25 and the audio record data 23 when these records are sent to the data transfer agent 28:

a5/d17. a Unique Record Identifier; and,

a6/d18. a Call Center Site Code.

Other data fields, of course, can be added or not as desired.

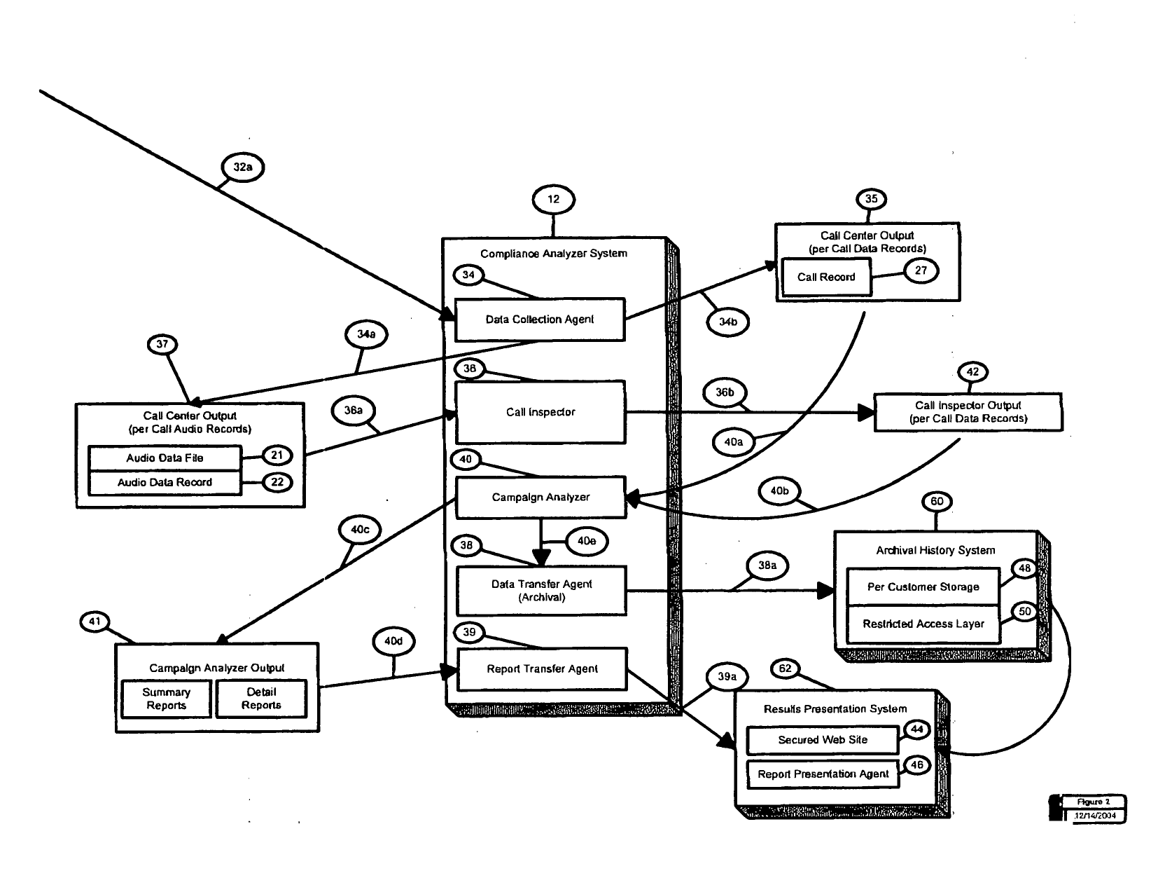

The call record data 25 and the audio record data 23 are then regularly transferred out of the compliance monitor 10 by the data transfer agent 28. This is accomplished on line 32 via a system such as a Wide Area Network (WAN) or the internet and via line 32 a to a data-collection agent 34 of the compliance analyzer 12 (FIG. 2). That data is then further transferred on line 34b from the data-collection-agent section 34 to a per-record data section 35 of the compliance analyzer 12 where the compliance-monitor call record data for each call center is stored. With respect to FIG. 2, the Compliance Analyzer System includes a data-collection agent 34, a call inspector section 36, a campaign analyzer section 40, an archival data transfer agent 38 and a report transfer agent section 39.

Call center output data collected by the data-collection agent 34 of the compliance analyzer 12 is stored in two separate areas, an area for data 35, and if desired, an area for audio records 37. The call data records 35 are transferred directly to the campaign analyzer 40. If desired, the audio data records 37 are transferred to the call inspector 36 which “listens” to the audio data records 22 that have been collected and stored in a call center output section 37 by the data-collection agent 34 and creates an output in a call inspector output section 42 of its interpretation of what it hears in the recordings and sends that data to the campaign analyzer 40. Further the campaign analyzer 40 of the compliance analyzer 12 merges the call record data 35 and the call inspector output 42, compares that data with the FTC/FCC rules and creates output on a line 40c to a campaign analyzer output section 41 which determines how the operation of a given campaign relates to the FTC/FCC rules. This output is derived from the data that has been gathered in the campaign analyzer 40.

A typical format of merged records in the campaign analyzer might be:
1. For all records, a unique Record Identifier
2. For all records, a unique Call-Center Site-Code
3. For all records, the consumer telephone number dialed
4. For all records, the time the recording analysis is initiated
5. For all records, the digits pulsed to the PSTN
6. For all records, the date and time the ringing begins during analysis.
7. For records that are deemed a connect, the date and time during analysis of the consumer's completed greeting.
8. For records that are deemed to be a connect, the date and time during analysis of the initiation of the agent's response to the greeting
9. For records that are deemed to be non-answered calls, the date and time during analysis each call was determined to be a no answer
10. For all records, a call classification wherein preferred classifications may be such as:
   (i) Answering machine (AM)
   (ii) No answer (NA)
   (iii) Live Connects
      a) abandoned call (AC)
      b) sent to an agent (LC)
   (iv) Busy signals (BU)
   (v) Disconnected numbers (DS)
   (vi) Blocked numbers (BN)
   Other classifications can be added or not as desired.
11. For all records that are deemed to be a connect and then an abandon, whether a pre-disconnect message was played (Yes or No).
12. For records that are deemed to be an abandon, the date and time during analysis the disconnect message playing was initiated.
13. For records that are deemed to be out of compliance, a specific code indicating the compliance violation(s).
14. The unique code number associated with the filename of each audio recording which generated a given result.

Anomalies in the resulting data, if any, are analyzed by the Campaign Analyzer 40 against the standards set by the FTC/FCC. The campaign analyzer 40 creates a summary and detail-report output 41 which is transferred to a results presentation system 62 by the report transfer agent 39 on lines 40d and 39a.

Any anomalies that are detected are flagged and may be reported in suitable summary and detailed formats (not shown).

The reporting application also does the necessary calculations to produce a compliance summary report. A typical compliance summary report might be as follows:

| | |
|---|---|
| Campaign ID: 35252 | Report Date: May 1, 2003 |
| Campaign Name: Telemarketing 1 | Report Interval: 00:00-23:59 |

| | |
|---|---|
| Section 1: Call Abandonment | |
| Total Number of Dials | 102,426 |
| Total Number of Live Connects: | 67,242 |
| Maximum Abandonment Setting for Live Calls (%): | 04.00% |
| Minimum Abandonment Setting for Live Calls (%) | 01.00% |
| Actual Average Abandonment Rate for Live Calls (%) | 02.11% |
| Actual number of Abandoned Calls | 1423 |
| Section 2: PreDisconnect Message Status | |
| Total Calls Abandoned Requiring Disconnect Message: | 1423 |
| Abandonment Message Played: | 1422 |
| Disconnect Message Success Rate: | 99.93% |
| Section 3: Wait before terminating call | |
| Actual Minimum No Answer Wait Time (seconds): | 31 |
| Average No Answer Wait Time (seconds): | 35 |
| Section 4: Caller ID | |
| Caller ID Activated: | True |
| Section 5: 2 Seconds to Connect | |
| Actual Maximum Time to Connect (seconds): | 1.821 |
| Average Time to Connect (seconds) | 0.724 |

Independent of the call inspector 36, the campaign analyzer 40 creates reports based upon the call center output 35. The data contained within the individual call records 27 are analyzed and such parameters, among others, as ring times, live connect data, and recorded announcements are utilized in report creation.

The campaign analyzer section 40 produces output that is then delivered on line 40c to the analyzer output section 41. The output is delivered through line 40d to the report transfer agent 39 component of the compliance analyzer system. The report transfer agent then formats and delivers through line 39a resultant report sets to the results presentation system 62. The report presentation agent 46 component of the results presentation system 62 utilize a secured website 44 to display reports to the requestor.

The report transfer section 39 of the compliance analysis system 12 also delivers data on line 39a to a results presentation system 62 which gives access to all desired data and reports by means of a conventional secure access line to customers, call-center personnel, FTC/FCC personnel and the like. Hence, telemarketers are able, if desired, to substantiate issues such as the following:
Total # of Dials
Total Number of Connects
Average Abandonment Rate
Total of Abandoned Calls
Total Calls Abandons Requiring the Play of a Disconnect Message
Total Abandonment Messages Played
Abandonment Message Success Rate
Minimum No Answer Wait Time in Seconds
Average No Answer Wait Time in Seconds
Maximum Time to Connect a Call in Seconds
Average Time to Connect All Live Calls in Seconds
Other items can be added to the report, or not, as desired.

In addition to the summary report, the results presentation system 62 permits a browser-based utility to allow for searching and displaying detail from data within the results presentation system 62, for each specific telephone number that has been dialed so that clients at given call-center sites can easily access and distribute call detail whenever it is desired to do so. In this manner, it is possible to present a call history in the event that a complaint is made by a consumer. This detail may also be replicated by the campaign analyzer as output over line 40e to the archival data transfer agent 38, stored in a per-customer storage section 48 of an archival history 60, and archived in a restricted database 50.

The FTC/FCC regulations call for telemarketers to maintain at least two years of data for all calls placed from their predictive dialers. The archival history section 60 of the system of the invention maintains such compliance data while minimizing customer expense. Preferably, this is accomplished at an off-site location from the compliance analyzer as described above. Conventional site-to-site data encryption on-line permits the archived data to be presented at remote locations through the results presentation system 62 via standard internet browser techniques. In this manner, the call center (telemarketer) is permitted to focus on its call center activities and eliminates the need for the telemarketer separately to maintain costly hardware for archiving data and extracting such data from the archives.

A preferred reporting package based on the above-described system includes summary and detail reports as noted above. Such reports demonstrate both compliance with FTC/FCC requirements and exceptions to those requirements. Conventional spread-sheet analysis also permits generation of a call-center compliance score of between, for example, 0 and 100 quickly to show where a given call-center site ranks in compliance; and, moreover, these reports can be generated from the report transfer agent 38 and downloaded from the results presentation system 62 to individual call-center sites and/or FTC/FCC compliance facilities through normal internet connections.

While the invention has been specifically shown and described with reference to preferred embodiments, it should be understood by those skilled in the art that various changes in form and detail may be made therein without departing from the spirit and scope of the invention.

The embodiments of the invention in which an exclusive property or privilege are claimed are defined as follows:

1-29. (canceled)

30. Apparatus for assessing compliance with FTC/FCC predictive dialer requirements comprising:
a predictive dialer for dialing selected calls;
a call-log data record for recording data necessary to determine for a selected call by said predictive dialer whether said call meets FTC/FCC requirements for calls from a consumer telemarketer;
a compliance analyzer;
a data transfer agent for transferring data from said call-log data record to said compliance analyzer, said compliance analyzer being operative to analyze said data transferred thereto to determine whether it is in compliance with said FTC/FCC requirements; and
a result presentation system for generating a report to demonstrate compliance with said FTC/FCC requirements.

31. The apparatus of claim 30 wherein said call-log data record includes data necessary to determine for a selected call one or more of the following:
whether it was a live contact and, if so, whether it was abandoned;
the length of time between a completed greeting of an answering party and the connection of the call to an agent; and
the length of time a party's phone rang before a determination was made that there was “no answer”.

32. The apparatus of claim 31 wherein said compliance analyzer is adapted to determine one or more of the following:
whether the number of abandoned calls exceed a predetermined percentage of live contacts;
whether a given live contact was connected to an agent within a predetermined time period;
whether a given phone was permitted to ring for a given period of time before the call was determined to be a “no answer”; and
whether a pre-disconnect announcement was played when a given call could not be connected to an agent within a predetermined time period.

33. The apparatus of claim 30 wherein said call-log data record includes data necessary to determine for a selected call one or more of the following:
whether it was a live contact and, if so, whether it was abandoned;
the length of time between a completed greeting of an answering party and the connection of the call to an agent; and
the length of time a party's phone rang before a determination was made that there was “no answer”.

34. The apparatus of claim 30 wherein said compliance analyzer is adapted to determine one or more of the following:
whether the number of abandoned calls exceed a predetermined percentage of live contacts;
whether a given live contact was connected to an agent within a predetermined time period;
whether a given phone was permitted to ring for a given period of time before the call was determined to be a “no answer”; and
whether a pre-disconnect announcement was played when a given call could not be connected to an agent within a predetermined time period.

35. Apparatus of claim 30 including an audio recorder for recording given calls.

36. Apparatus of claim 30 wherein said predictive dialer and said call-log data record are located at a first location and said Compliance analyzer is located at a remote location.

37. The apparatus of claim 36 wherein said compliance analyzer receives data from a plurality of data transfer agents.

38. The Apparatus of claim 30 wherein said call-log data record includes call-log data records of each call and each said call-log data record includes one or more of the following fields:
for all outbound dials, the consumer telephone number dialed;
for all outbound dials, the date and time each call was initiated;
for all outbound dials, an identification of the physical outbound-line upon which the call was dialed;
for live contacts only, the date and time of an answering party's completed greeting.
for live contacts only, the date and time the call was transferred to an agent;
for non-answered calls only, the date and time each call was determined a no answer.
for all outbound dials, a call classification of whether the call received one or more of the following:
a busy signal, a live answer, an answering machine, a modem/fax, a disconnect tone, an abandoned call indication and no answer;
for all abandoned calls, whether a pre-disconnect message was played; the date and time such pre-disconnect message was initiated; and
a description of the message that was played.

39. The apparatus of claim 30 including a Compliance monitor for monitoring the activity of calls from a given location.

40. The apparatus of claim 39 wherein said data transfer agent is located in said compliance monitor.

41. The apparatus of claim 39 including an audio recorder for recording given calls.

42. The apparatus of claim 41 wherein said recorder is located in said compliance monitor.

43. The apparatus of claim 39 wherein said compliance monitor includes a data recorder for receiving and recording data from said call-log data record.

44. The apparatus of claim 39 wherein said predictive dialer and said call-log data record and said compliance monitor are located at a first location and said compliance analyzer is located at a remote location.

45. The apparatus of claim 43 wherein said compliance monitor also includes said data-transfer agent and an audio recorder for recording given calls.

46. The apparatus of claim 45 wherein said compliance analyzer receives data from a plurality of data transfer agents.

47. A compliance analyzer for receiving information data for a given call campaign from a predictive dialer and analyzing said information data, said compliance analyzer comprising:
a data collection agent for receiving said information data from said predictive dialer;
a call inspector for accepting audio data from said predictive dialer, comparing said audio data with FTC/FCC requirements, and generating an output representing an extent of compliance with said FTC/FCC requirements; and
a campaign analyzer for accepting call information from said data collection agent and said output from said call inspector, generating an output representing detected call anomalies, and generating an output analysis of said campaign.

48. The compliance analyzer of claim 47 a per-call data recorder for recording data from said call inspector.

49. The compliance analyzer of claim 48 including an audio data storage file and a call-record storage file and delivery means for delivering audio data and call-record data from said data collection agent to said audio data file and said call-record storage file.

50. The compliance analyzer of claim 47 including an archival transfer agent for accepting archival data from said campaign analyzer; and
an archival history system for accepting said archival data from said archival transfer agent for storage.

51. The compliance analyzer of claim 47 including a report transfer agent for receiving campaign and compliance data from said campaign analyzer; and
a results presentation system for receiving said campaign and compliance data from said report transfer agent and generating a results presentation.

52. The compliance analyzer of claim 48 wherein said results presentation system is accessible to permitted parties by means of an internet browser.

53. The apparatus of claim 30 wherein said compliance analyzer includes
a data collection agent for receiving said information data from said predictive dialer;
a call inspector for accepting audio data from said predictive dialer, comparing said audio data with FTC/FCC requirements, and generating an output representing an extent of compliance with said FTC/FCC requirements; and
a campaign analyzer for accepting call information from said data collection agent and said output from said call inspector, generating an output representing detected call anomalies, and generating an output an analysis of said campaign.

54. The apparatus of claim 53 wherein said compliance analyzer includes
a data collection agent for receiving said information data from said predictive dialer;
a call inspector for accepting audio data from said predictive dialer, comparing said audio data with FTC/FCC requirements, and generating an output representing an extent of compliance with said FTC/FCC requirements.

55. A method of assessing compliance by a predictive dialer with FTC/FCC requirements comprising:
using said predictive dialer for dialing selected calls;
maintaining a call-log data record which includes data necessary to determine for a selected call by said predictive dialer whether said call meets FTC/FCC requirements for calls from a consumer telemarketer;
using a data transfer agent to transferring data from said data record to a compliance analyzer, said compliance analyzer being operative to analyze said data transferred thereto to determine whether it is in compliance with said FTC/FCC requirements; and
using a result presentation system for generating a report to demonstrate compliance with said FTC/FCC requirements.

56. The method of claim 55 including the steps of locating said predictive dialer at a first location and locating said compliance analyzer at a second location.

57. The method of claim 55 including the steps of comparing audio data from said predictive dialer with FTC/FCC requirements and generating an output representing the extent of compliance with said FTC/FCC requirements; and
using said campaign analyzer to detect anomolies in the data generated by said campaign analyzer.

58. The method of claim 55 including the step of storing audio data and call-record data in an audio storage file and a call-record storage file.

59. The method of claim 56 including the step of permitting access to said result presentation system by an internet browser.
